(19) United States
(12) Patent Application Publication
(10) Pub. No.: US 2006/0249622 A1
(43) Pub. Date: Nov. 9, 2006

(54) Autonomous Environmental Control System and Method For Post-Capture and Pre-Launch Management of an Unmanned Air Vehicle

(75) Inventor: Daniel W. Steele, Clay, NY (US)

Correspondence Address: BOND, SCHOENECK & KING, PLLC, ONE LINCOLN CENTER, SYRACUSE, NY, 13202-1355, US

(73) Assignee: LOCKHEED MARTIN CORPORATION, Bethsda, MD (US)

(21) Appl. No.: 10/908,255

(22) Filed: May 4, 2005

(51) Int. Cl. B64F 1/12

(52) U.S. Cl. 244/115

(57) ABSTRACT

An embodiment of the invention is directed to a system for controlling and managing a small unmanned air vehicle (UAV) between capture and launch of the UAV. The system includes an enclosure that provides environmental protection and isolation for multiple small UAVs in assembled and/or partially disassembled states. Control and management of the UAVs includes reorientation of a captured UAV from a landing platform and secure hand-off to the enclosure, decontamination, de-fueling, ingress to the enclosure, downloading of mission payload, UAV disassembly, stowage, retrieval and reassembly of the UAV, mission uploading, egress of the UAV from the enclosure, fueling, engine testing and launch readiness. An exemplary system includes two or more robots controlled by a multiple robot controller for autonomously carrying out the functions described above. A modular, compact, portable and autonomous system of UAV control and management is described.

### RELATED APPLICATION DATA

This application is related to U.S. application Ser. No. ______ entitled robotically assisted launch/capture platform for an unmanned air vehicle, filed concurrently herewith and incorporated by reference herein in its entirety to the fullest allowable extent.

### DESCRIPTION

1. Field of Invention

Embodiments of the invention pertain to an environmental control system and, more particularly, to an autonomous, robotically-assisted system and method for attending to a small unmanned air vehicle (UAV) between capture and launch of the UAV.

2. Background of the Invention

The use of UAVs to conduct surveillance or fly other payload missions in remote and/or hostile environments or under dangerous conditions has significant benefits. The most obvious of these benefits is the avoidance of human exposure to these environments. Other benefits derive from the ability to equip a UAV with data collection instruments and sensors that provide the capability to collect a large quantity of data over a large data collection area or physically dangerous data without human intervention.

The two most common mission scenarios for small UAVs involve a mobile, land-based host platform such as a truck or trailer, for example, and a ship-based host platform including deep water and shallow water vessels. The ship-based mission platforms present the more challenging environments. Vessel platforms may be highly unstable due to rolling, pitching and yawing, and other unpredictable movements of the vessel in choppy water as well as to the forward motion of the ship itself. In addition, small, fixed-wing UAVs on the order of 10 to 300 pounds can be highly vulnerable to airwake turbulence from the vessel superstructure and prevailing winds, and the UAV may have to be captured and stabilized within a very limited space on an already crowded deck. Furthermore, the environmental conditions of a sea-based host platform (and to a lesser degree, a land-based host platform) can be extremely harsh due to constant exposure to salt water, wind, snow, sand and a variety of hostile weather conditions.

Strategically, leveraging the capabilities and strengths of small UAVs, i.e., unmanned air vehicles weighing between about 10-300 pounds and nominally about 100 pounds, is ultimately driven by the ability to effectively manage large numbers of them, particularly without or with a minimum of human intervention. Such management involves the complete handling of the UAV between capture and launch. This may include one or more of the following: reorientation and traversal of the captured UAV, de-fueling, decontaminating, off-loading of dangerous payload, environmental isolation (for severe host platform scenarios such as a ship at sea), data download, multiple UAV storage (with or without disassembly), retrieval for launch readiness (with or without assembly), mission programming, egress from environmental isolation, fueling, engine testing, launch set-up and other activities appreciated by those skilled in the art.

Current solutions to address these issues involve manpower intensive operations with the attendant delays and risks, which are likely unacceptable in extensive multiple deployments and mobile operations on both land and sea.

Accordingly, there is a recognized need for a system and associated methods for autonomously managing and executing some or all of the aforementioned functions. Such a system benefits from being highly automated and integrated, relatively compact and modular for ease of retrofit and portability, and designed and constructed in a manner that maximizes physical and mechanical survivability under constant, extreme environmental conditions. The system will also benefit from being operationally integrated with UAV launch and capture capability.

### SUMMARY OF THE INVENTION

An embodiment of the invention is directed to a system for controlling and managing a small unmanned air vehicle (UAV) between capture and launch of the UAV. The system includes an enclosure that provides environmental protection and isolation for multiple small UAVs in assembled and/or partially disassembled states. In an aspect, the enclosure incorporates an environmentally sealable entry/exit location for a UAV. The enclosure further provides storage space for multiple UAVs as well as protected space for a variety of components and/or platforms for autonomously performing all of the necessary functions to receive a captured UAV returning from a mission and preparing it (or a different UAV) for launch on a new mission. These functions include some or all of the following: reorientation of the captured UAV from a landing platform and secure hand-off from the landing platform to the enclosure; UAV engine testing and shutdown; decontamination; UAV de-fueling; UAV ingress to the enclosure; downloading or off-loading of, and/or testing of UAV mission payload; partial or complete disassembly of the UAV; UAV stowage within the enclosure; retrieval from stowage and reassembly of the UAV; mission uploading; egress of the UAV from the enclosure; refueling; pre-launch engine testing and launch readiness. The system further includes operationally-integrated components or platforms for autonomously carrying out the functions described above. In an aspect, these components or platforms include two or more robot manipulators (hereinafter referred to as robots), which are to the maximum extent possible controlled from a single control point; i.e., by a multiple robot controller. In an aspect, the system includes one or more multiple robot controllers. Thus, two or more commonly controlled robots are programmed and controlled to handle some or all of the various operations on a UAV between its capture upon returning from a mission and launching on a new mission. The enclosure with the commonly controlled robots can provide what is currently referred to as a ‘jigless fixturing’ or ‘flexible fixturing’ or ‘adaptive robotic’-type environment, as those terms are understood in the art (see, e.g., Hardin, Flexible Fixturing on the Rise, Robotics Online, http://www.roboticsonline.com). According to various aspects of the embodiment, the system (including the structural and functional features/characteristics of the enclosure and platforms contained therein) is modularized, self-contained, portable, adapted for use on a ship-based host platform or on a land-based (fixed or mobile) host platform, and may be self-propelled and remotely programmable. In a particular aspect, the system is capable of launching a UAV and/or capturing an in-flight UAV. This can be accomplished by interfacing the system to a launch/capture platform such as that described in related co-pending U.S. application Ser. No. ______ entitled robotically assisted launch/capture platform for an unmanned air vehicle, the disclosure of which is incorporated by reference herein in its entirety to the fullest allowable extent.

The disadvantages, shortcomings and challenges in the current state of the art, as well as objects and advantages of the invention will be addressed and met by embodiments of the invention described below with reference to the detailed description and drawings that follow, and by embodiments of the invention as defined in the appended claims.

### BRIEF DESCRIPTION OF THE DRAWINGS

FIG. 1 is a schematic, head-on illustration of an integrated system interfaced to a launch/capture platform according to an embodiment of the invention;

FIG. 2 is a block process diagram showing the various required and optional functions carried out by the system according to an embodiment of the invention;

FIG. 3 is a schematic diagram of an exemplary enclosure showing a decontamination and fueling/de-fueling station; and

FIG. 4 is a top-down view of an enclosure according to an embodiment of the invention.

### DETAILED DESCRIPTION OF A PREFERRED EMBODIMENT OF THE INVENTION

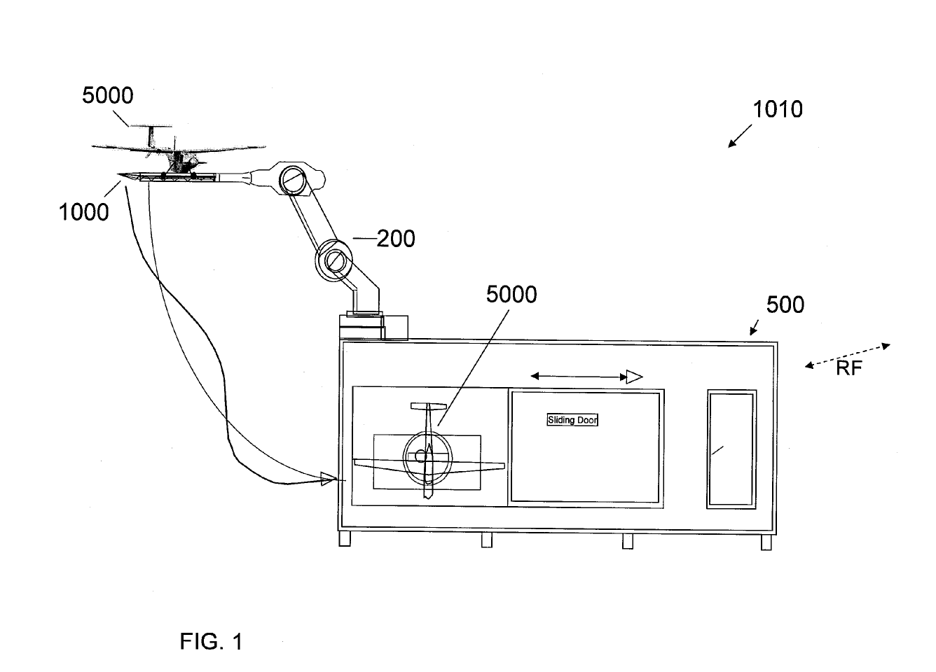

An embodiment of the invention is directed to a system for autonomously controlling and managing a small unmanned air vehicle (UAV) after a UAV has been captured and prior to relaunching the UAV or launching a different UAV. FIG. 1 schematically shows a frontal view of a system 1010 comprising an enclosure 500 for, among other things, receiving a UAV 5000, storing the UAV and providing the same or a different UAV in a launch-ready condition. As shown in FIG. 1, a robotic manipulator 200 is externally interfaced to the enclosure 500 and includes a launch/capture platform 1000 shown with a captured UAV 5000. Although the system 1010 as illustrated in FIG. 1 includes an externally mounted launch/capture platform, embodiments of the instant invention are primarily directed to the enclosure 500 and the various components and processes (described in greater detail below) for carrying out required and optional tasks on a UAV after it has been captured from a mission and prior to launching the UAV for a mission. Specific details about a launch/capture system as illustrated by the robot arm 200 and platform 1000 in FIG. 1 can be found in co-pending U.S. patent application Ser. No. _______ entitled robotically assisted launch/capture platform for an unmanned air vehicle, which is incorporated herein by reference by its entirety.

Non-limiting scenarios for the location of a system 1010 according to embodiments of the invention include the deck of a ship at sea, a smaller vessel in littoral waters, mounted to a fixed or mobile land-based host platform or on a self-contained mobile platform (not shown). In the case where the host platform is a deep water naval vessel, for example, it will be appreciated that the environmental conditions encompassing the system can be extremely harsh. As such, a purpose for the enclosure 500 is to provide an environmentally isolated space for the UAV between capture and launch. To maintain isolation, it will be advantageous to provide ingress and egress of the UAV as quickly and efficiently as possible and to isolate the interior region of the enclosure from external environmental conditions to the greatest extent possible. In an exemplary embodiment of the enclosure 500 as illustrated in FIG. 1, an automatically controlled sliding door 502 provides an opening 501 for ingress and egress of a UAV. It is to be understood, however, that various other door designs including, e.g., a revolving door platform that can translate in and out of the enclosure, other arrangements such as, e.g., physical or gaseous curtains, and other techniques and structures for providing a sealable entry/exit-way, are fully within the scope of the embodied invention. Alternatively, more than one door may be provided, for example, on each side of the enclosure 500 to interlace multiple launches and retrievals.

Before presenting a description of the system components for handling the UAV, it is to be understood that the externally mounted robot arm 200 in combination with the launch/capture platform 1000 is designed and will be programmed to present the UAV 5000 to the enclosure 500 in the vicinity of the opening 501, whereupon means will be provided from within the enclosure (described below) to access the captured UAV 5000 from the platform 1000 for ingress to the enclosure. Simil a launch-ready UAV to be delivered from within the enclosure to the platform 1000 for launching. Thus the line and arrow 202, 203 in FIG. 1 represent translation, rotation, reorientation and other manipulation of the UAV and the platform by the robot arm 200 and a controllable platform connector (not shown).

Since the remaining components and features of the system 1010 and enclosure 500 engage either an outer surface of the enclosure or are contained within the enclosure, it will be appreciated that the system 1010 is integrated and modular, allowing relatively simplified retrofit of components, compactness and portability.

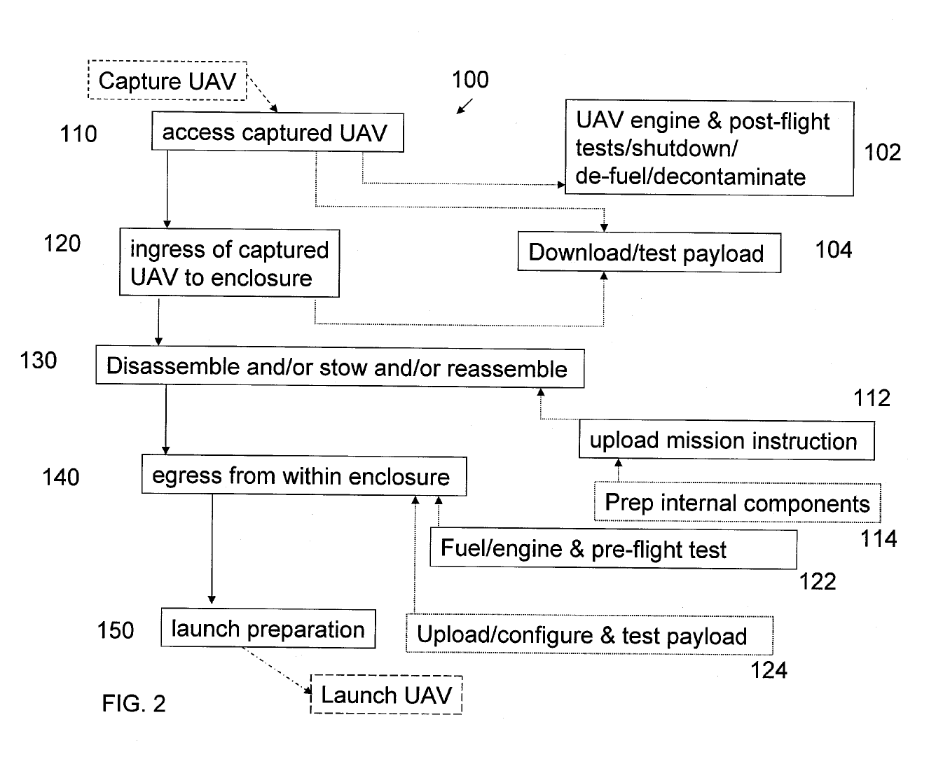

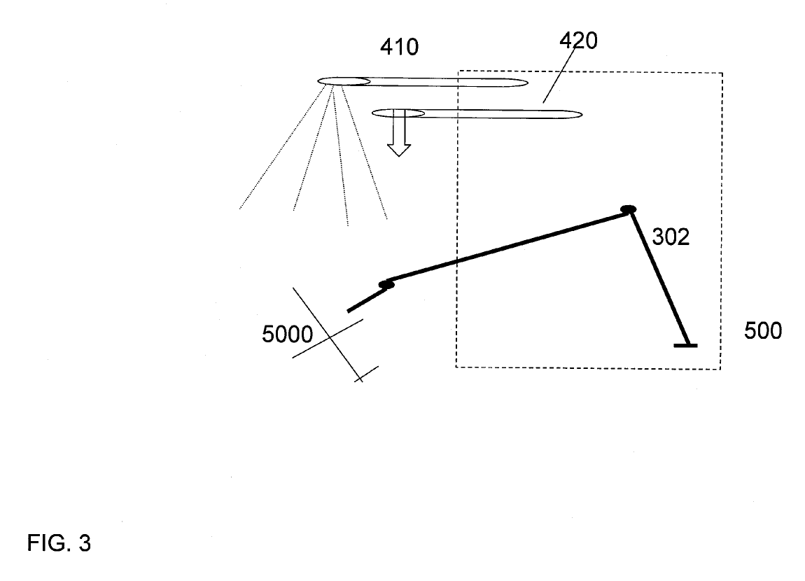

FIG. 2 provides a flow chart description 100 of the various required and optional process steps performed on a UAV during a post-capture and pre-launch cycle. Starting from the point of a captured and locked-down UAV on platform 1000, the system 1010 must access the captured UAV as shown at step 120. The UAV can then be brought into the enclosure as set forth at step 120, or several optional steps can first occur. For example, as shown at step 102, the UAV can be shut down, post-flight tests can be conducted, the UAV can be decontaminated, and/or de-fueled. In an exemplary aspect disclosed in conjunction with FIG. 3, the accessed UAV 5000 is held outside of the enclosure by means to be discussed in greater detail below, and is decontaminated by being washed off with water, acetone or a similar solvent or cleansing agent dispensed from a nozzle 410 that projects through the exterior of the enclosure 500. It will be appreciated that the process of decontamination will depend upon the nature of the contamination, which may range from dirt and salt residue at one extreme to toxic biochemical or radioactive contamination. As such, decontamination component 410 is illustrative only of an exemplary wash system and should not be construed as limiting with regard to aspects of the invention. A subsystem 420 is also illustrated in FIG. 3 for de-fueling and fueling a UAV, depending upon the mission sequence. The subsystem 420 may include retractable fuel supply and drain lines as well as associated mechanisms by which to provide and extract fuel from the UAV. It will be appreciated that if the UAV is first cleaned, defueled and decontamined prior to actual entry within the enclosure, safety and cleanliness standards important to disassembly and repeated use of UAV components, including payloads, can be maintained.

Another UAV operation that may be performed exterior to the enclosure is the downloading and/or testing of a mission payload as set forth at step 104. This, again, will depend upon mission parameters as the payload may include physical data, chemical data, optical data, electronic data or other forms of environmental or mission parameter data that will be more suitably downloaded from the UAV outside of the enclosure rather than inside, or vice versa. Post-flight testing of UAV components, including payload, may be important with regard to inventory status and eventual reuse of the components. The UAV can then be brought into the enclosure 500 as shown at step 120. As mentioned above, the nature of the mission payload may make it appropriate to download some or all of the mission data after the UAV is securely within the enclosure.

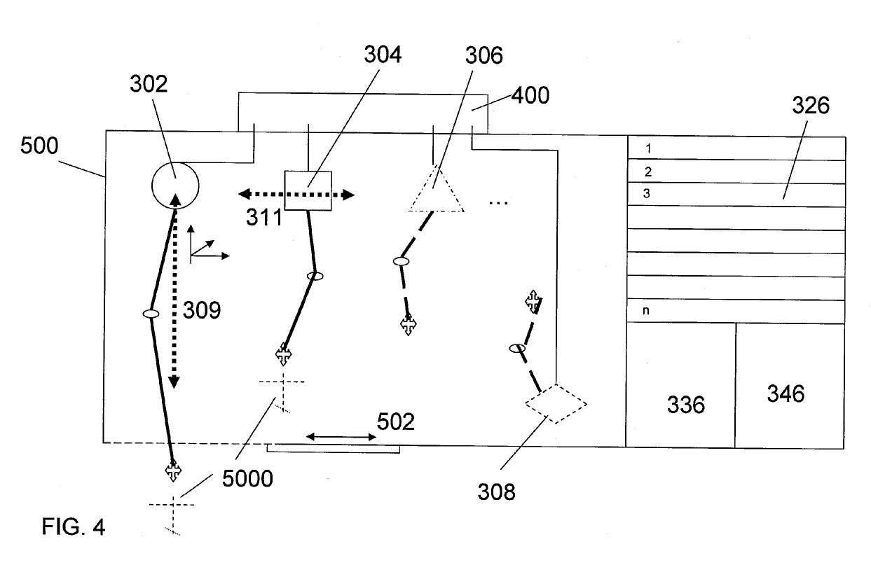

According to an embodiment, the enclosure will provide space for multiple UAVs, as the capabilities and strengths of small UAVs are leveraged by the ability to effectively manage large numbers of them. In an exemplary aspect, the enclosure 500 will provide for on the order of 50 UAVs, however, the exact number may be more or less depending upon enclosure dimensions and host platform constraints. Accordingly, it may be necessary or desirable to at least partially disassemble the UAV and stow each UAV or the various disassembled parts thereof in modular compartments 326 illustrated as 1, 2, 3. . . n in FIG. 4. To the extent that one or more UAVs are disassembled and stowed, each UAV, with or without payload (when modularly separate), will then need to be reassembled for launch readiness. Spaces 336, 346 illustrate additional modular work spaces within the enclosure 500. The illustration of two spaces 336, 346 is not intended to limit the number, size, arrangement, design or functionality of workspace within the enclosure.

A next series of steps are directed at preparing a UAV for launch. This process may begin with the reassembly of the UAV as set forth at step 130. At this point, the process sequence may optionally include uploading mission instructions to the UAV as shown at step 112, and preparing certain internal components of the UAV for launch and mission control as shown at step 114. Mission instruction and preparation can be performed with direct electrical or optical links to the UAV, or may be transmitted through RF communication links, satellite links, and so on.

A properly assembled and prepped UAV can now be delivered from the enclosure as set forth at step 140. In addition, the UAV can be fueled, and it may be desirable to perform an engine test including engine starting and diagnostics as shown at step 122. Further, as shown at step 124, a payload may be uploaded, configured and tested, alternatively to step 112 or in addition thereto. The UAV is now prepared for launch at step 150 and can be delivered to a launch platform 1000 as shown, for example, in FIG. 1.

According to an embodiment of the invention, means are provided for performing all of the necessary functions and, to the level desired, the optional functions, by an automated, autonomous system. In an exemplary embodiment, the means for performing at least two of the functions recited as steps 110-150 in FIG. 2 are performed by at least two robot manipulators (“robots”), which are operationally interfaced to the enclosure on the inside thereof and are controlled by a minimum number (at least one) of multiple robot controllers, which are known to control multiple robots from a single control point. Robots such as those referred to herein, as well as multiple robot controllers, are manufactured and commercially available from Motoman Company (Carrollton, Ohio, USA). In an exemplary aspect, the robots are Motoman UP165 robots and are interfaced to the Motoman NX100 multiple robot controller.

FIG. 4 is a top-down looking view into the interior of an enclosure 500 according to an exemplary embodiment of the invention. At least a first robot 302 and a second robot 304 having articulated, multi-axis manipulator arms as illustrated are operationally mounted within the enclosure 500 and are interfaced to a multiple robot controller 400. Robot 302 may be positioned on a track 309 allowing the robot to be moved closer to and further away from the sealable opening 511 of the enclosure to facilitate access to and handling of the UAV 5000. Likewise, robot 304 may move along a track 311. The tracks need not be straight or linear but may be configured appropriately to allow the robots to carry out some or all of the functions as depicted in FIG. 2. Third and fourth robots 306, 308 respectively, may be present and would also be interfaced to the multiple robot controller 400. The NX100 multiple robot controller referred to above enables multiple robot control of up to four robots from a single point of control. Embodiments of the invention, however, are not limited to a specific number of robots or multiple robot controllers; rather, in an exemplary aspect a minimum number of robots (at least two) and a minimum number of multiple robot controllers (at least one) are intended to access, manipulate, and otherwise handle the one or more UAVs associated with a particular mission between the conditions of capture, lockdown and launch.

The implementation of robots 302, 304 (and others as necessary) controlled by a common robot controller 400, and in conjunction with a communications link, a data link and an external command center enable a jigless fixturing environment within the enclosure 500. This type of arrangement enables the adaptive manipulation of a UAV including access from a capture platform, decontamination of the UAV, ingress to the enclosure, disassembly of the UAV, UAV stowage, uploading and downloading of mission payload, retrieval from stowage, reassembly of the UAV, egress of the UAV from the enclosure, fueling/de-fueling of the UAV and preparation of the UAV for launch. It is contemplated that a captured UAV can be brought in, operated upon as described, and prepared for launch (the same or a different UAV) within an approximately two minute cycle time. All operations are automated and performed autonomously thus resulting in a highly efficient and safe means for leveraging a strategic UAV mission platform.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for autonomously controlling and managing a small unmanned air vehicle (UAV) between a capture and a launch of the UAV, comprising:
an enclosure;
a) means for accessing a captured UAV;
b) means for ingress of the captured UAV to the enclosure;
c) means for at least one of i) disassembling the UAV within the enclosure, ii) storing the UAV within the enclosure, and iii) retrieving the UAV from storage within the enclosure;
d) means for egress of the UAV from within the enclosure; and
e) means for readying the UAV for launch.

2. The system of claim 1, further comprising at least one multiple robot control means for controlling at least two robotic components of means (a-e) from a single control point.

3. The system of claim 1, wherein the means for disassembling the UAV includes means for at least partially disassembling the UAV.

4. The system of claim 1, wherein the means for storing the UAV within the enclosure includes means for storing the disassembled parts of the UAV.

5. The system of claim 1, wherein the means for retrieving the UAV from within the enclosure includes means for reassembling the UAV.

6. The system of claim 1, further comprising means for at least one of decontaminating and defueling the captured UAV.

7. The system of claim 6, wherein the at least one of the decontamination means and the defueling means are external to the enclosure.

8. The system of claim 1, further comprising means for downloading a payload from the captured UAV.

9. The system of claim 1, further comprising means for uploading a mission instruction for the UAV prior to launching the UAV.

10. The system of claim 1, further comprising means for at least one of fueling the UAV and making an engine test of the UAV, prior to launching the UAV.

11. The system of claim 1, wherein the enclosure includes a space for storing a plurality of disassembled UAVs.

12. The system of claim 11, wherein the space can accommodate 50 or more disassembled UAVs.

13. The system of claim 1, further comprising means for at least one of launching a UAV and capturing an in-flight UAV.

14. The system of claim 1, wherein the means (a-e) are fully automated.

15. The system of claim 14, comprising a common controller programmed to coordinate the operation of means (a-e).

16. The system of claim 1, wherein the system is a modular system.

17. The system of claim 16, wherein the system is a portable system.

18. The system of claim 1, wherein the system provides at least one of a launch cycle and a capture cycle having a cycle time of equal to or less than two minutes.

19. The system of claim 1, wherein the enclosure incorporates an environmentally sealable entry/exit.

20. The system of claim 1, wherein the system is adapted for operation on a ship-based host platform.

21. The system of claim 1, wherein the system is adapted for operation on a land-based host platform.

22. The system of claim 1, wherein the system is a self-propelled, land-based platform.

23. A system for autonomously controlling and managing a small unmanned air vehicle (UAV) between a capture and a launch of the UAV, comprising:
an enclosure;
at least a first robot and a second robot operationally interfaced to the enclosure and programmed and controlled to perform at least two of: i) access a captured UAV, ii) retrieve the accessed UAV into the enclosure, iii) disassemble the UAV within the enclosure, iv) store the UAV within the enclosure, v) retrieve the UAV from storage within the enclosure, and vi) prepare the UAV for launch; and
at least one multiple robot controller programmed to control the at least first and second robots from a single control point.

24. The system of claim 23, wherein at least one of the at least first and second robots is programmed to partially disassemble the UAV within the enclosure.

25. The system of claim 23, wherein at least one of the at least first and second robots is programmed to store the disassembled parts of the UAV.

26. The system of claim 23, wherein the enclosure includes a plurality of modular compartments for stowage of a plurality of disassembled UAVs.

27. The system of claim 23, wherein at least one of the at least first and second robots is programmed to reassemble the disassembled parts of the UAV.

28. The system of claim 23, further comprising means for at least one of decontaminating and defueling the captured UAV.

29. The system of claim 28, comprising a UAV washing station.

30. The system of claim 28, comprising a UAV fueling station.

31. The system of claim 28, wherein the at least one of the decontamination means and the defueling means are external to the enclosure.

32. The system of claim 23, further comprising means for downloading a payload from the captured UAV.

33. The system of claim 23, further comprising means for uploading a mission instruction for the UAV prior to launching the UAV.

34. The system of claim 23, further comprising means for at least one of fueling the UAV and making an engine test of the UAV, prior to launching the UAV.

35. The system of claim 23, wherein the enclosure includes a space for storing a plurality of disassembled UAVs.

36. The system of claim 23, wherein the system is a portable system.

37. The system of claim 23, wherein the system provides at least one of a launch cycle and a capture cycle having a cycle time of equal to or less than two minutes.

38. The system of claim 23, wherein the enclosure incorporates an environmentally sealable entry/exit.

39. The system of claim 23, wherein the system is adapted for operation on a ship-based host platform.

40. The system of claim 23, wherein the system is adapted for operation on a land-based host platform.

41. The system of claim 23, wherein the system is a self-propelled, land-based platform.
